(19) United States
(12) Patent Application Publication
(10) Pub. No.: US 2024/0337605 A1
(43) Pub. Date: Oct. 10, 2024

(54) FABRIC QUALITY CONTROL ASSEMBLY

(71) Applicant: AGTEKS ORME VE TEKSTIL ENDUSTRILERI SANAYI VE TICARET LTD. STI., Istanbul (TR)

(72) Inventor: Mehmet AGRIKLI, Istanbul (TR)

(73) Assignee: AGTEKS ORME VE TEKSTIL ENDUSTRILERI SANAYI VE TICARET LTD. STI., Istanbul (TR)

(21) Appl. No.: 18/294,176

(22) PCT Filed: Aug. 19, 2022
(86) PCT No.: PCT/TR2022/050876

§ 371 Date: Feb. 1, 2024

(30) Foreign Application Priority Data
Oct. 25, 2021 (TR) 2021/016610

(51) Int. Cl. G01N 21/898; D06H 3/08

(52) U.S. Cl. CPC G01N 21/8983; D06H 3/08

(57) ABSTRACT

An assembly is provided for conducting quality control of objects in the form of linear movable fabric. The assembly includes at least one light source, at least one light detection unit, and an electronic processor unit. The fabric and the light detection unit include a drive means configured to make a linear relative movement with respect to each other, and the light detection unit is configured to receive a linear image at a given moment in a direction different from the direction of the linear relative movement.

### CROSS-REFERENCE TO THE RELATED APPLICATIONS

This application is the national phase entry of International Application No. PCT/TR2022/050876, filed on Aug. 19, 2022, which is based upon and claims priority to Turkish Patent Application No. 2021/016610, filed on Oct. 25, 2021, the entire contents of which are incorporated herein by reference.

### TECHNICAL FIELD

The present invention relates to an assembly for quality control of objects in fabric form.

### BACKGROUND

Within the scope of the invention, the terms “fabric” or “object in fabric form” should be understood as woven, knitted, etc. structures formed with all yarn, fiber-shaped objects that are composite or not composite, twisted or not twisted, technical or non-technical, or that have undergone or not undergone any chemical or physical treatment.

The fabric is used in many industrial fields, especially in the textile industry. Fabric must have various qualities (quality elements) according to its area of use or during its production in person. For example, matters such as lump, needle runny, stain, layer print, filamentation, yeast print, elastane yarn runny, knot formations, missing warp or weft yarn, and hole formation in the fabric are not desirable because it disrupts the fabric texture. Early detection of such effects is important, as the fabric is in constant flow both in production and in final use (e.g., fabric quality control, fabric spreading machine, warp knitting machine, weaving or knitting machines). Therefore, the late diagnosis (or failure to diagnose during production) of the aforementioned disruptive effects causes product casualties. It is practically reasonable to check whether a fabric is of the expected quality, that is to say, that the quality control is carried out with a various number of sensors lying side by side like a line during the linear movement of the fabric, and it is known in the art that various solutions are proposed in this regard.

DE10123870 discloses an assembly in which the fabric exiting a weaving loom is monitored by means of a series of electro-optical sensors. The sensors are connected to an image error detection system. The image captured at any given moment is compared with an image captured at the next moment after a predetermined time interval and a decision is made.

KR101749782 discloses an image capture device for capturing image data from a fabric. The image data includes the pixel value of the fabric crossing the field of view of the image capturing device. Detected image data is processed in an analysis computer by means of various normalization algorithms. The analysis computer calculates a normalized value for each pixel of the image data as a weighted sum of the results obtained from applying at least two pixels of the normalization algorithm, pixel normalization algorithm using pre-recorded parameters.

### SUMMARY

The object of the present invention is to ensure effective fabric quality control.

To achieve its object, the present invention relates to an assembly that performs quality control by superficial scanning of the fabric. An assembly according to the invention relates to an assembly comprising at least one light source configured to emit rays on the fabric, at least one light detection unit configured to detect the rays reflected from the said fabric, an electronic processor unit connected with at least one light sensor, the said fabric and light detection unit comprising a drive means configured to make a linear relative movement with respect to each other, and the said at least one light sensor being configured to receive a linear image at a certain time in a direction different from the said linear relative movement direction.

According to the invention, the linear image taken at a given moment is at least 100 dpi in resolution.

According to the invention, the linear image acquisition rate is at least 300 lps.

A possible embodiment of the invention is characterized in that the said light detection unit comprises at least one first light sensor array comprising a plurality of light sensors arranged longitudinally and at least one second light sensor array.

A possible embodiment of the invention is characterized in that the said first light sensor array and the said second light sensor array are arranged in the light detection unit in such a way that they extend on a horizontal axis and at least one of the sensors is located on the same axis vertically. Thus, the blind spot formed in the image is prevented due to the gap between the sensor arrays provided side by side.

A possible embodiment of the invention is characterized in that it comprises a pointer light source controlled by the electronic processor unit, it is configured to enable the pointer light source to emit light in case the electronic processor unit detects an error in the fabric.

A possible embodiment of the invention is characterized in that the said pointer light source is positioned facing the fabric and is configured to enable the operation of the pointer light source to indicate the part of the fabric detected in the event of an error detected by the electronic processor unit. Thus, it is ensured that the error is presented to the operator visually.

A possible embodiment of the invention is characterized in that the said pointer light source is configured to emit light in at least two different colors and the electronic processor unit is configured to detect the type of error and to allow the pointer light source to emit light in the selected color according to the type of error. Thus, it is ensured that the error type is presented to the operator.

A possible embodiment of the invention is characterized in that the plurality of provided light sources are configured to emit light at different wavelengths from one another. In this way, possible faulty determinations are prevented.

A possible embodiment of the invention is characterized in that the said drive means is configured to enable the fabric to pass in front of the light sensor.

A possible embodiment of the invention is characterized in that it comprises at least a first focal support and a second focal support positioned at a distance downstream thereof to limit the distance of the fabric to the light sensors, which are given an inclined form at the front of the said housing.

A possible embodiment of the invention is characterized in that it comprises a damping means for enabling the first focal support and the second focal support to make a damping movement between the fabric and the housing.

A possible embodiment of the invention is characterized in that the said housing comprises at least one protective window in the light-permeable structure at least partially provided between the light sensor and the fabric to ensure that the light sensor is protected from external factors.

According to an embodiment of the invention, the term “a direction different from the direction of linear relative motion” may preferably refer to the direction perpendicular (90°) to the flow direction of the fabric or light sensor. According to another embodiment of the invention, the sensor can be positioned to make any angle with the flow direction of the fabric or the light sensor. The fabric should be positioned at the sensor's focal point. The focal point can vary from 0 mm to 20 mm depending on the sensors that may be preferred for different applications.

According to an embodiment of the invention, at least one separate (second) light source may be used. This second light source can be positioned on the other side of the fabric, where there is no sensor relative to the fabric. In this case, control operations can be carried out by detecting the shadow, not the reflection of the light from the second light source. In such a case, the quality control of both sides of the fabric can preferably be done simultaneously. That is, when the fabric or light sensor is moving, for example, the image obtained by the reflection of the first light source can be processed first, and then the image obtained by the shadow of the second light source can be processed.

According to an embodiment of the invention, the electronic processor can be configured with an algorithm capable of learning the fabric pattern. In such an embodiment, the fabric to be controlled may not require further processing, such as comparing the fabric to a type of fabric previously defined in the electronic processor memory.

According to an embodiment of the invention, the electronic processor may be connected to other processors or controllers. Thus, various actions can be taken regarding the quality controlled fabric. For example, when the assembly according to the invention is used on a loom or the knitting machine, fabric production may be terminated according to the case. Or, errors that are captured without stopping production can be reported by specifying the coordinate on the fabric, the captured error image can be given to the user and the captured errors can be named.

### BRIEF DESCRIPTION OF THE DRAWINGS

The invention should be evaluated together with the figure explained below in order to better understand the embodiment of the invention and its advantages together with the attachments thereof.

FIG. 1, FIG. 2, and FIG. 3 show representative views of possible embodiments of light sources and light sensors.

FIG. 4 shows a representative image where the light sensors are arranged in a housing.

FIG. 5 shows a cross-sectional view of the assembly of the invention.

FIG. 6 shows a representative side view is shown where the light sensors are arranged in a housing and the fabric is mobile.

FIG. 7 shows a representative side view of the light sensors being arranged in a housing and the light sensors being mobile.

FIG. 8 shows a representative side view of the arrangement where the effective light source and light sensor are on different sides according to the fabric.

FIG. 9 shows a representative cross-sectional image in which the light sensors are arranged in a housing and each light sensor is connected to a separate processor.

FIG. 10 shows a representative image if the signal received from the light sensors is analog.

FIG. 11 shows that the signal received from the light sensors is analog and a representative image corresponding to a single-processor arrangement.

FIG. 12 shows that the signal received from the light sensors is digital and a representative image corresponding to a single-processor arrangement is given.

FIG. 13 shows a representative view corresponding to a hypothetical situation in which the light sensors are not positioned.

FIG. 14 shows a representative view corresponding to the situation where the light sensors are positioned.

FIG. 15 shows a representative view of the pixels that are excluded from the calculation when the light sensors are positioned.

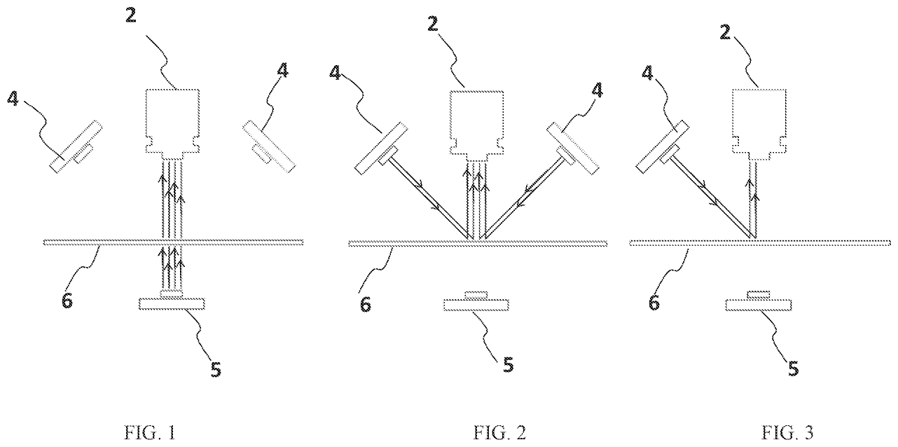

### DESCRIPTION OF THE REFERENCE NUMBERS OF THE PARTS SHOWN IN THE FIGURES

1 Housing
2 Light detection unit
2.1 First light sensor array
2.2 Second light sensor array
4 First light source
5 Second light source
6 Fabric
7 Overlapping distance
8 Electronic processor unit
9 First focal support
10 Second focal support
11 Lost area
12 Slot wall
13 Calibration line
14 Counter focal support
15 Pointer light source
16 Protective window
17 First non-calculated pixels
18 Second non-calculated pixels
19 Analog digital converter
20 Network connection
21 Central control computer
22 Upper drum
23 Lower drum
24 First motion arm
25 Second motion arm

### DETAILED DESCRIPTION OF THE EMBODIMENTS

The fabric quality control assembly of the invention essentially comprises a light detection unit (generally represented by the number 2), a first light source (4) emitting light such that it can be sensed by the light detection unit (2), and an electronic processor unit (8) with light detection unit (2) connection. The light detection unit (2) according to the invention comprises a longitudinal form such that it can receive a linear image. The longitudinal dimension of the light detection unit (2) can be selected as desired, e.g. 0.5, 1, 2, 3 m. etc. The light detection unit (2) may include a plurality of photodiodes or other types of light sensors arranged side by side to form the longitudinal structure. Here, the sensors contained in the light detection unit (2) are defined as light sensors.

According to one embodiment of the invention, the first light source (4) is configured to be on the same side with respect to the fabric (6) to be quality controlled. The first light source (4) and the light detection unit (2) can be positioned at a distance perpendicular to the face of the fabric (6) to be controlled, for example 10-12 mm. According to an embodiment of the invention, the light detection unit (2) and the first light source (4) may be located in a uniform structure (i.e., “on-board”) or the light detection unit (2) may be configured to be independent but located in the vicinity thereof. The first light source (4) may be a light source, such as an ultraviolet (UV), visible colored RGB LED or infrared (IR) LED, capable of emitting radiation at a wavelength between 100 nm and 1100 nm, as known from the art. The number and position of light sources can be selected as desired.

According to an embodiment of the invention, depending on the structure of the sensor to be used, there should be a certain focal length between the fabric (6) and the light detection unit (2). This focal length may, for example, be between 0 mm and 20 mm. The fabric (6) is positioned at the focal length of the light detection unit (2).

The beam emitted from the first light source hits the surface of the fabric (6) and reflects to the light detection unit (2), and the color data of the reflected light is perceived side by side in pixels. For example, 2592 pixel data can be received from a light detection unit (2) and sent to the electronic processor unit (8) for processing. According to an embodiment of the invention, the image received by the light detection unit (2) at any given moment is not less than 100 dpi resolution, preferably between 200 dpi and 2,400 dpi. The most preferred resolution is 300 dpi. The light detection unit (2) can receive linear images in the speed range of 300 to 6,000 lps per second along the width of the fabric (6) to be quality checked and transfer these image data to the electronic processor unit (8) one after the other. The most preferred speed value is 500 lps.

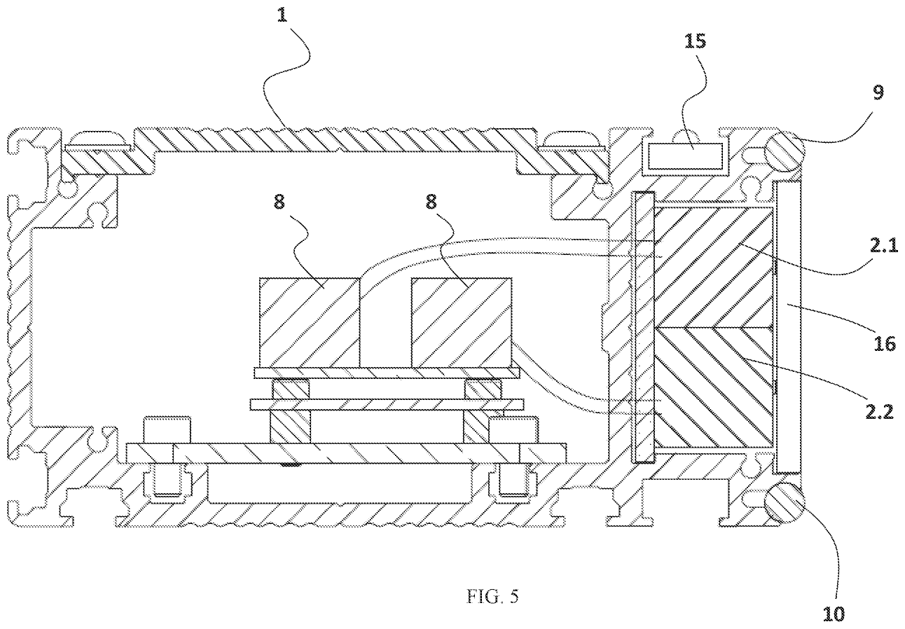

The light detection unit (2) can be placed in a longitudinal housing (1) standing on the ground by means of the legs (not necessarily shown in the drawings). A first focal support (9), which is given an inclined form at the front of the housing (1), and a second focal support (10), which is positioned at a distance downward from it, are provided. As seen in FIG. 5, the fabric (6) flows in contact with the inclined surfaces of this first focal support (9) and the second focal support (10). In other words, the first focal support (9) and the second focal support (10) contact the fabric (6) passing in front of the light detection unit (2), limiting and fixing the focal distance of the fabric (6) towards the light detection unit (2).

The first focal support (9) and the second focal support (10) are preferably connected to the housing (1) by means of damping such as a spring. In this way, possible vibrations can be attenuated while the fabric (6) is moving. On the other hand, by changing the length and/or spring constants of a damping means, such as a spring, the distance between the first focal support (9) and the second focal support (10) and the housing (1) can be changed. This is particularly beneficial in terms of adjusting the focal length between the aforementioned fabric and the light sensor. For example, in cases where a light sensor with a certain focal length must be replaced by another light sensor with a different focal length, this focal length becomes interchangeable.

The movement of the fabric (6) may be provided by a drive assembly known in the art. For this, for example, the bowl mechanism is capable of being used. As seen in FIG. 5, the fabric (6) can be moved around an upper drum (22) and a lower drum (23). Here, an engine (not necessary to be shown) can drive the lower drum (23). In such an embodiment, the fabric (6) is movable, the light sensors and the processor are stationary.

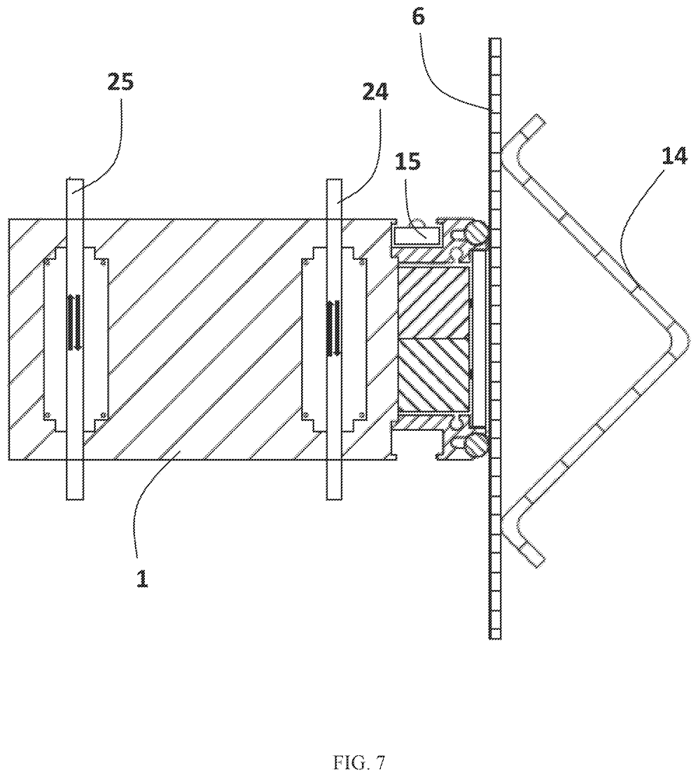

In particular, in cases where the length of the fabric (6) is relatively small, it may be possible to move the light detection unit (2) by keeping the fabric constant, thereby combing the fabric. As shown in FIG. 7, the housing (1) carrying the light detection unit (2) can be moved. A first motion arm (24) and a second motion arm (25) extending parallel to each other may be fixed to the housing (1) and the arms (24,25) may be moved back and forth in the direction of the arrows by means of a motor (not necessary to be shown). In such an embodiment, with the light detection unit (2), the light sources may preferably be arranged as “on-board”. The second light source (5) on the other side of the fabric (6) can also be mechanically connected with the light detection unit (2) and moved together. In this embodiment, the electronic processor unit (8) can be held in a fixed state if desired.

The housing (1) comprising the light detection unit (2) can be used as an independent unit or, if desired, adapted to the outlet side of a weaving loom, a knitting machine or any fabric production machine.

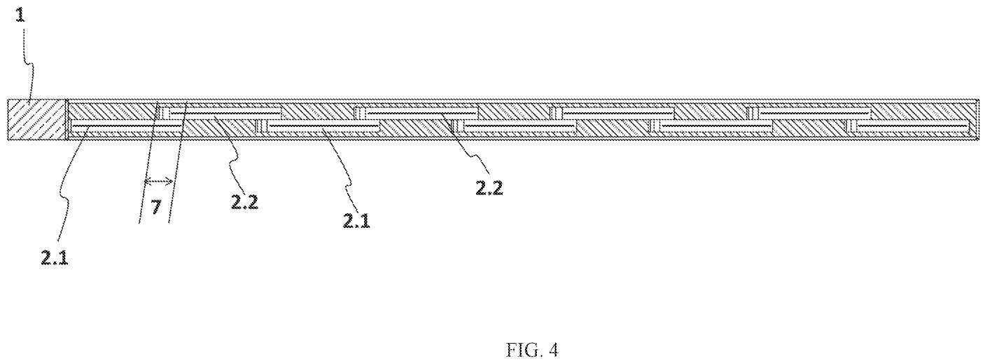

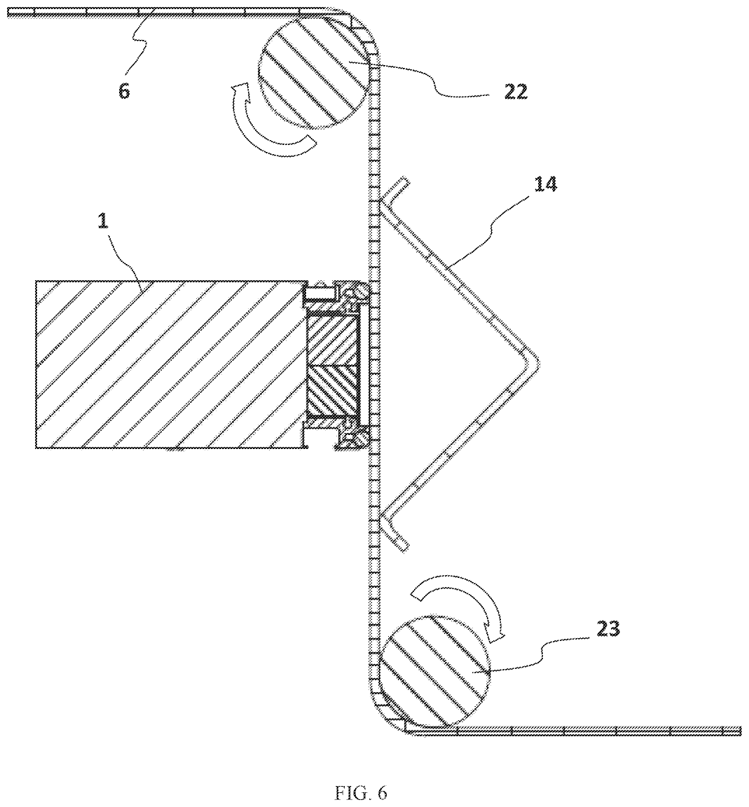

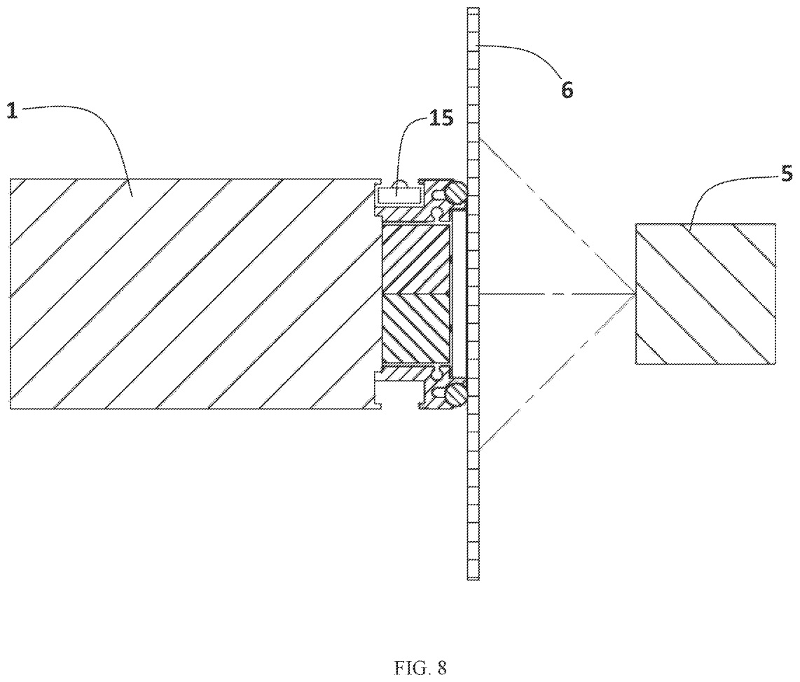

As shown in FIGS. 3 to 11, the light detection unit (2) may comprise multiple light sensors relative to the width of the fabric (6) and/or the length of the light detection unit (2), the array of light sensors formed by juxtaposing the plurality of light sensors. In such a case, according to an advantageous embodiment of the invention, a first light sensor array (2.1) and a second light sensor array (2.2) can be positioned in an off-set manner, i.e., so as to remain somewhat lower/higher relative to each other and to remain axially at an overlapping distance (7). The overlap will be particularly beneficial in terms of preventing image acquisition losses caused by the thickness of the slot wall (12) in which each light sensor is placed. In other words, in an exemplary sequence, the first light sensor array (2.1) and the second light sensor array (2.2) are partially placed on top of each other in a step-like form. The first light sensor array (2.1) and the other sensors in addition to the second light sensor array (2.2) are also positioned to complete the step form downward and upward. In other words, it is arranged in a way that it is similar to two rows of bricks stacked on top of each other on a wall, but there is enough distance between the lateral consecutive bricks.

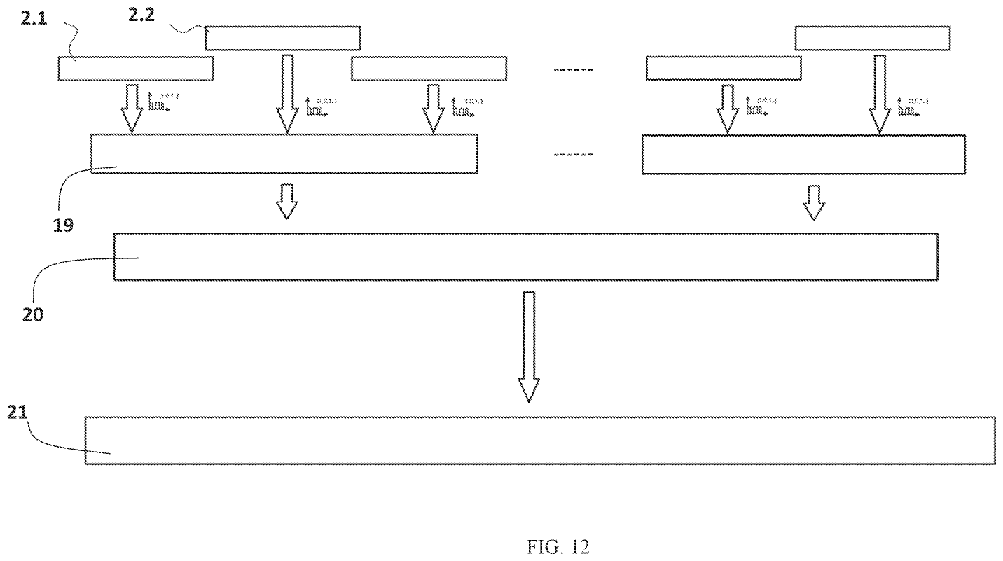

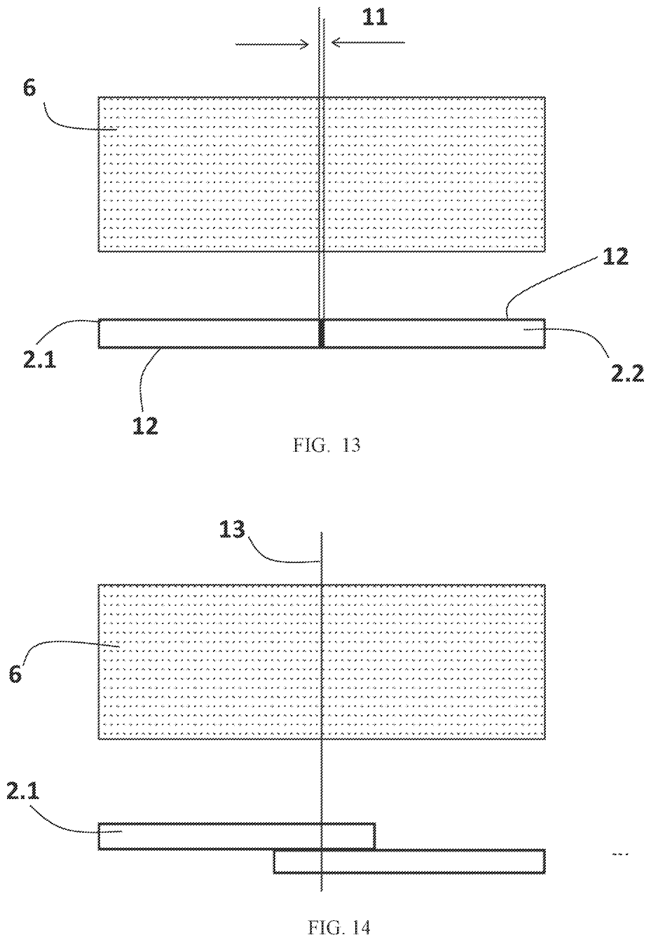

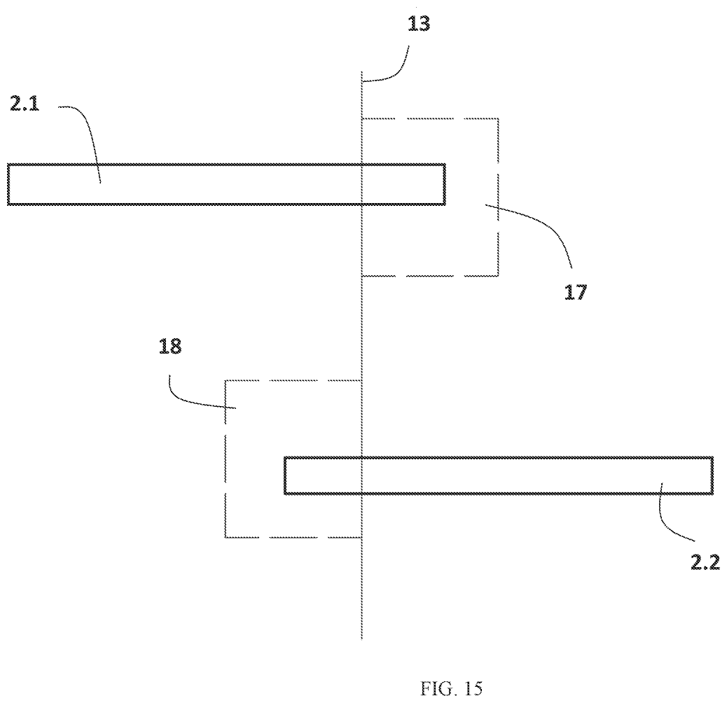

When the first light sensor array (2.1) and the second light sensor (2.2) are placed without overlapping as shown in FIG. 12, an unimaginable lost area (11) occurs. In accordance with the invention, when the first light sensor array (2.1) and the second light sensor array (2.2) overlap, a calibration line (13) is determined and the data obtained from the remaining pixels are evaluated by excluding the pixels (17) on the right side of the first sensor array (2.1) according to the calibration line (13) and the pixels (18) on the left side of the second sensor array (2.2) according to the calibration line (13) as seen in FIG. 13 and FIG. 14. In other words, in accordance with the example, the image is created by combining the pixel data on the left side of the first sensor array (2.1) with respect to the calibration line (13) and the pixel data on the right side of the second sensor array (2.2) with respect to the calibration line (13). In practice, the factor forming the calibration line (13) may be provided by means of a part, such as a thin plate having a thickness of several pixels. The location, thickness, fabric texture, etc. of such a thin plate in the overlap area may optionally be selected, taking into account factors.

According to an embodiment of the invention, a counter focal support (14) is provided on the other side of the fabric (6), i.e. the side where the light detection unit (2) and the first light source (4) are not located, in longitudinal form, which can be closed and opened towards the fabric (6). The counter focal support (14) may be in various geometric forms, such as cross-section V, U, C. The open mouth side of the counter focal support (14) contacts the back of the fabric and exerts a slight pressure on the fabric. Thus, the vibration of the moving fabric can be reduced.

The parts where the counter focal support (14) contacts the fabric (6) may be the corresponding parts of the first focal support (9) and the second focal support (10) on the other side of the fabric (6). The sensitivity of the data received from the light sensor (2) when the cover (14) is in the closed position is higher, and this is due to the establishment of a dark part on the other side of the fabric (6) when the cover (14) is closed. In other words, when the light detection unit (2) (or its sensors) is in the closed position, it is aligned to correspond to the inside of the counter focal support (14). The inner surface of the counter focal support (14) facing the fabric may include a dark/matt color.

According to an embodiment of the invention, another, second light source (5) may be used. The second light source (5) is positioned to beam in particular to the other side of the fabric (6). According to a preferred embodiment of the invention, the shadow of light from the second light source (5) is sensed by the light detection unit (2) and processed in the electronic processor unit (8). The data provided by the second light source (5), in particular, may be useful in detecting quality defects on the other side of the fabric. The first light source (4) and the second light source (5) can be activated simultaneously and a continuous quality control can be performed on both sides of the fabric. According to one embodiment of the invention, when a second light source (5) is used, the cover (14) may not be used.

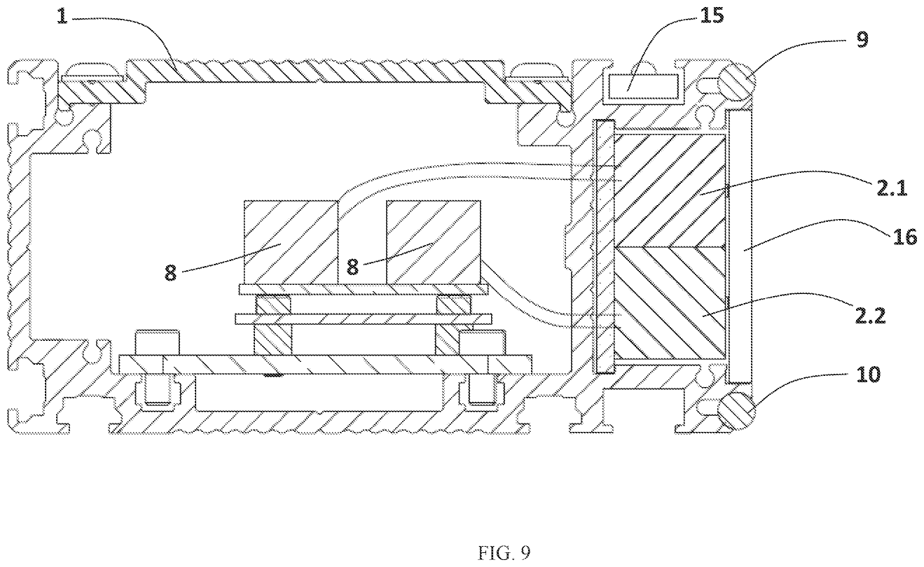

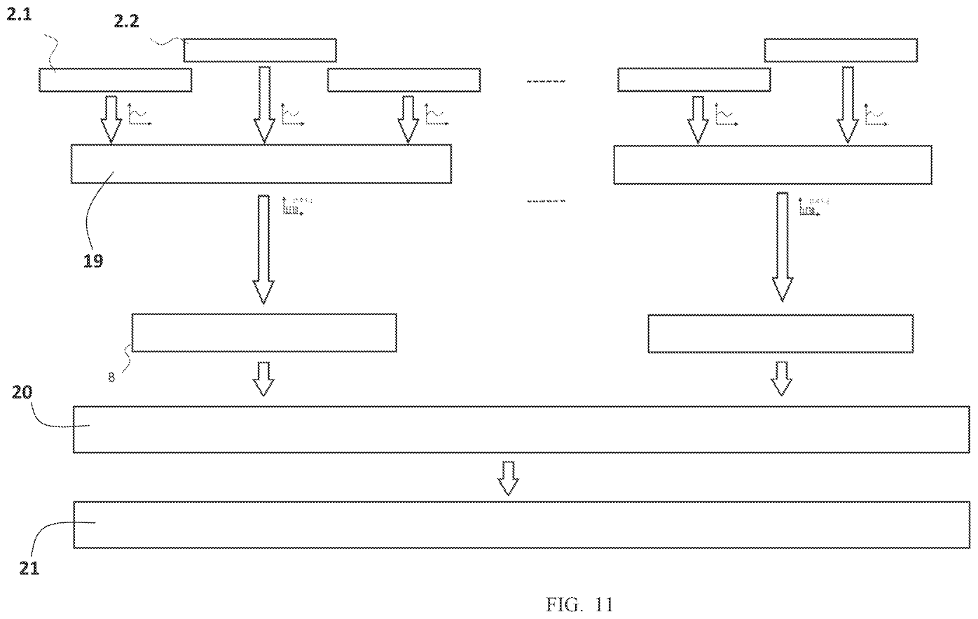

According to an embodiment of the invention, the output information of the light detection unit (2) may be in analog or digital form. In the case where data is received in analog form, the analog signal can be transferred to the processor (8) by converting it into a digital signal by means of an analog digital converter (19) as shown in FIG. 9. In case it is digital as shown in FIG. 11, the data can be received with communication protocols such as parallel logic output, LVDS, Ethernet, USB etc. and transferred to the processor (8).

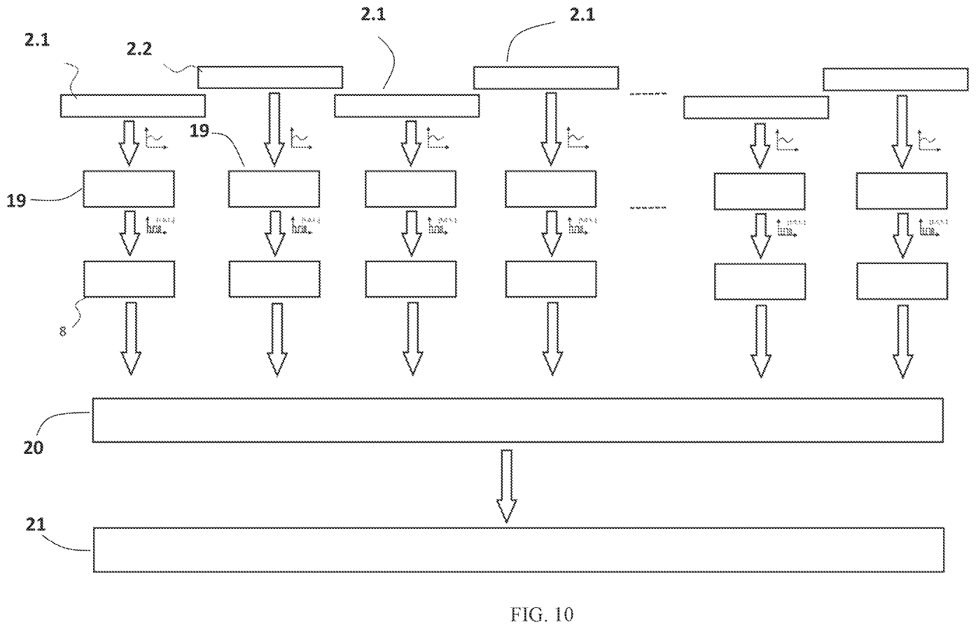

According to an embodiment of the invention, the processor cards can be positioned behind the light sensors (2) or the data received from the light detection unit (2) can be moved to the processors positioned at a remote point with a speed of at least 100 Mbps in digital form. In this way, the assembly according to the invention can have a smaller size structure as in FIG. 10 or FIG. 11.

According to the invention, the electronic processor unit (8) may consist of one or more components with high-speed digital data processing capability, such as a microcontroller, DSP (digital signal processor), FPGA, a computer with an operating system. As shown in FIG. 9, a processor can be used for each light sensor. A single processor can be used for more than one sensor if the data is moved away as shown in FIG. 10 or FIG. 11. Fabric pattern data is obtained as a result of processing the data in the processor and this data can be sent to a central control computer (21) via a network connection (20) as shown in FIG. 9 to FIG. 11.

According to the invention, the algorithm underlying the quality control of a fabric can be arranged in two ways. According to the first embodiment, the digital data of the fabric pattern to be controlled may have been previously stored in a data source, and the fabric pattern data obtained by operating the assembly according to the invention may be compared dynamically with the said pattern data, i.e. with image processing data obtained by signals received from the light detection unit (2) while the fabric is moving (or the light sensors are moving). In such a comparison, various tolerance ranges can be defined algorithmically for the similarity of the fabric pattern data obtained dynamically with the model pattern data. On the other hand, the aforementioned data source may be located in an assembly according to the invention in the form of a data memory or may be located at a distant point. This remote point may, for example, be the control computer of a central station where a plurality of weaving machines are operated.

According to the second algorithm regulation, which constitutes the basis for the quality control of the fabric, the model pattern information of the fabric to be controlled can be created dynamically. A pattern learning algorithm can be used for this. For example, the data obtained in response to the signals received from the light sensors while the fabric is moving for a certain period of time (for example, within 10-30 seconds) can be stored in a memory as model fabric pattern information (a reference value). Subsequently, the data obtained as the fabric continues its linear movement can be compared dynamically with this model pattern information. Again in this application, various tolerance ranges for pattern similarity can be defined algorithmically. According to the said second algorithmic embodiment, the assembly according to the invention may be capable of automatic calibration. In other words, a change in ambient conditions that may cause a change in the perceived light intensity may not cause a change in the function of the assembly.

A protective window (16) is provided between the fabric (6) and the light detection unit (2) in a possible embodiment of the invention. The protective window (16) comprises a wall made of light-permeable material. The protective window may comprise a wall of glass. The protective window (15) prevents the light detection unit (2) from being exposed to foreign substances that may come from the fabric, medium or any source. In a possible embodiment of the invention, the protective window (16) is provided in a partially permeable structure. In more detail, it is configured to allow light to pass in accordance with the characteristic of the light emitted by the light sources. Thus, the effect of unwanted external lights that will cause incorrect detection is reduced.

A pointer light source (15) connected to the electronic processor unit (8) is provided in a possible embodiment of the invention. The electronic processor unit (8) operates the pointer light source (15) when it detects an error in the fabric (6). In another possible embodiment of the invention, the processor unit (8) determines the region where the error is detected when an error is detected in the fabric (6) and enables the pointer light source (15) to send a pointing light to this region. The pointer light source (15) may be located facing the fabric (6) on the y-axis. The pointer light source (15) may comprise a LED array, emitting light at different wavelengths depending on the type of error. The electronic processor unit (8) may determine the position of the error according to the relative amount of motion provided by the fabric-moving devices to the fabric or the relative amount of motion of the devices that enable the light detection unit (2) to move relative to the fabric. In a possible embodiment of the invention, a motion device (not shown in the figure) controlled by the electronic processor unit (8) that changes the orientation of the pointer light source (15) is provided. The electronic processor unit (8) detects the current position of the pointer light source (15), the current orientation, and the position of the fault, and controls the movement mechanism to ensure that the pointer light source (15) is moved to the faulty region.

According to an embodiment of the invention, fabric production can be terminated when an error is detected when the fabric is mobile (such as weaving loom, knitting machine, transfer machine or spreading machine) or when the fabric is stationary (such as a quality control table). Or, errors that are captured without stopping production can be reported by specifying the coordinate on the fabric, the captured error image can be given to the user and the captured errors can be named.

What is claimed is:

1. An assembly comprising at least one light source configured to radiate a beam to a fabric to perform quality control by superficial scanning of the fabric, at least one light detection unit configured to detect reflected rays from the fabric, an electronic processor unit associated with the light detection unit, wherein the fabric and the light detection unit comprise a drive means configured to make a linear relative movement with respect to each other, and the light detection unit is configured to receive a linear image at a given moment in a direction different from the direction of the linear relative movement.

2. The assembly according to claim 1, wherein the light detection unit comprises at least one first light sensor array and at least one second light sensor array, wherein the first light sensor array and the second light sensor array comprise a plurality of longitudinally arranged light sensors; the first light sensor array and the second light sensor array are arranged in the light detection unit to extend in a horizontal axis and at least one of the plurality of longitudinally arranged light sensors is located vertically on the same axis with respect to each other.

3. (canceled)

4. The assembly according to claim 1, wherein the assembly comprises a pointer light source controlled by the electronic processor unit, and the pointer light source is configured to emit light if the electronic processor unit detects an error in the fabric, the pointer light source is positioned to face the fabric and the pointer light source is configured to enable an operation of the pointer light source to indicate a portion of the fabric with a detected error if the electronic processor unit detects an error.

5. (canceled)

6. The assembly according to claim 4, wherein the pointer light source is selectively configured to emit light in at least two different colors, and the electronic processor unit is configured to detect a type of error and enable the pointer light source to emit light in a selected color according to the type of error.

7. (canceled)

8. (canceled)

9. (canceled)

10. (canceled)

11. (canceled)

12. (canceled)

13. The assembly according to claim 1, wherein the assembly comprises at least one second light source positioned to beam off to the other surface of the fabric, the plurality of provided light sources are configured to emit light at different wavelengths.

14. (canceled)

15. The assembly according to claim 13, wherein the said at least one light source and the said at least one second light source are configured to operate simultaneously.

16. The assembly according to claim 1, wherein the assembly comprises a counter focal support in the form extending along a width of the fabric to be positioned on a side of the fabric where the light sensor and the light source are not present, the counter focal support is configured to be closed and opened toward the fabric.

17. (canceled)

18. The assembly according to claim 1, wherein the assembly comprises a housing where the light detection unit is disposed.

19. The assembly according to claim 18, wherein the assembly comprises at least one first focal support and a second focal support positioned at a distance downstream thereof to limit the distance of the fabric, the fabric is sloped at a front of the housing, to light sensors.

20. The assembly according to claim 19, wherein the assembly comprises a damping means for enabling the first focal support and the second focal support to make a damping movement between the fabric and the housing.

21. The assembly according to claim 1, wherein a processor is configured to be connected to another processor, the another processor is a processor of a machine selected from the group consisting of a weaving loom, braiding machine, transfer machine, spreading machine, and quality control machine.

22. (canceled)

23. The assembly according to claim 1, wherein the electronic processor unit is configured to dynamically compare fabric pattern data obtained by the light detection unit with pattern data previously stored in a data source.

24. The assembly according to claim 1, wherein the electronic processor unit is configured to dynamically generate fabric pattern data obtained by a light sensor.

25. The assembly according to claim 1, wherein the electronic processor unit is configured to determine data obtained in response to signals received from light sensors while the fabric is moving for a predetermined period of time as a reference value and to compare data obtained as the fabric continues a linear movement of the fabric with these reference data values.

26. The assembly according to claim 18, wherein the housing comprises at least one protective window in a light-permeable structure at least partially provided between a light sensor and the fabric to ensure that the light sensor is protected from external factors.

27. The assembly according to claim 2, wherein the electronic processor unit is configured to dynamically generate fabric pattern data obtained by the light sensor.

28. The assembly according to claim 4, wherein the electronic processor unit is configured to dynamically generate fabric pattern data obtained by a light sensor.

29. The assembly according to claim 6, wherein the electronic processor unit is configured to dynamically generate fabric pattern data obtained by a light sensor.

30. The assembly according to claim 13, wherein the electronic processor unit is configured to dynamically generate fabric pattern data obtained by a light sensor.

31. The assembly according to claim 15, wherein the electronic processor unit is configured to dynamically generate fabric pattern data obtained by a light sensor.
